(19) United States
(12) Patent Application Publication
(10) Pub. No.: US 2003/0065916 A1
(43) Pub. Date: Apr. 3, 2003

(54) Method and apparatus for diagnosing the cause of a processor reset

(76) Inventors: Michael John Erickson, Loveland, CO (US); David R. Maciorowski, Parker, CO (US)

Correspondence Address: HEWLETT-PACKARD COMPANY, Intellectual Property Administration, P.O. Box 272400, Fort Collins, CO, 80527-2400, US

(21) Appl. No.: 09/918,025

(22) Filed: Jul. 30, 2001

(51) Int. Cl. G06F 15/177

(52) U.S. Cl. 713/2

(57) ABSTRACT

The invention provides methods and logic for determining the source of a processor reset in a system having a processor and a plurality of processor reset sources. The plurality of processor reset sources couple to a corresponding plurality of RS latches. One of the RS latches sets in response to a processor reset generated by one of the processor resets. That one RS latch writes logic high to a dedicated register of a read register. After rebooting, the processor reads the read register to determine which register is logic high, corresponding to the source that generated the reset. The read register is reset by writing logic high into a write register, thereby resetting the set RS latch and clearing the logic high register of the read register. The processor writes logic low to all write register bits to clear enable the RS latches so that subsequent processor resets are identified.

A portion of the disclosure of this patent application contains material which is subject to copyright protection. The copyright owner has no objection to the facsimile reproduction by anyone of the patent document or the patent disclosure, as it appears in the Patent and Trademark patent file or records, but otherwise reserves all copyright rights whatsoever.

### BACKGROUND OF THE INVENTION

Many products today incorporate embedded processors. In such products, there are several possible sources that may “reset” the processor. In one simple example, a push-button may reset the processor when manually pressed by a user of the product. In another example, when the product is used in control applications, the product may use a watchdog timer to reset the processor on detecting a latch-up or loss of control or activity. In a further example, a processor power monitor may reset the processor in the event of a power surge or outage.

In the prior art, however, the cause of the processor reset is not generally known; and yet this knowledge may assist a developer or administrator in diagnosing problems. For example, if the watchdog timer resets the processor, a firmware error is a likely cause. A power problem causing a reset by the power monitor, outside of initialization, may indicate an overall power management issue. Repeated push-button resets may indicate an errant user. Understanding the source of a processor reset would save time and effort in designing systems; it would further improve the overall product.

The prior art methods for diagnosing the cause of a processor reset include manually watching the reoccurrence of a reset with complicated electronics and devices, such as oscilloscopes, logic analyzers and the like. These methods are difficult to perform, particularly out of the laboratory. If required, direct access to product components and the processor printed circuit board may be difficult, further delaying debug procedures.

It is, accordingly, one object of the invention is to provide methods and apparatus for diagnosing the cause of a processor reset. Another object of the invention is to provide a processor with an internal or coupled register to track processor reset causes. Other objects of the invention are apparent within the description which follows.

### SUMMARY OF THE INVENTION

In one aspect, the invention provides a method of determining the source of a processor reset in a system having a processor and a plurality of processor reset sources. The method includes the steps of: coupling the plurality of processor reset sources to a corresponding plurality of latches; setting one of the latches in response to a processor reset generated by a corresponding one of the processor resets; writing logic high to a first register bit of a read register and designated by the one latch; rebooting the processor; and reading the first register bit from the read register to determine which of the reset sources generated the processor reset.

In a preferred aspect, the latches are RS latches. Those skilled in the art should appreciate that other latch logic may accomplish similar functions and yet fall within the scope of the invention. For example, the latches may also be constructed as master-slave flip-flops with latch logic.

In another aspect, the method includes the step of resetting the read register to determine a subsequent processor reset source. This step of resetting the read register may include the step of resetting the first register bit. The step of resetting the read register may include the step of writing logic high to a second register bit of a write register and corresponding to the first register bit. The step of resetting the read register may include the step of resetting the one latch through the logic high register bit of the write register.

In another aspect, the method may include the step of writing logic low to the first register bit and through the one latch. An additional step of the method may include the step of clear enabling the latches, such as by writing logic low to register bits of the write register.

In still another aspect, the invention provides logic that couples with a processor and a plurality of processor reset sources to determine which of the reset sources generated a processor reset. The logic includes a plurality of latches. Each of the latches is uniquely coupled to one of the reset sources. Each of the reset sources sets a corresponding latch when generating a processor reset. A read register couples to the latches such that each of the latches sets logic high in a corresponding read register bit of the read register in response to being set by a processor reset. The processor reads the register bit after rebooting to determine which of the sources generated the reset.

In one aspect, the logic includes a write register. The write register, read register and processor cooperate to set logic high in the write register bit of the write register corresponding to the logic high read register bit. The write register is coupled with the latches to reset one of the latches set by the processor reset. Preferably, this one latch resets logic low to the read register bit in response to being reset by the write register.

In another aspect, the processor writes logic low to each write register bit of the write register to clear enable the latches.

The read and/or write registers may utilize 8-bit registers to track up to 8 processor reset sources.

In yet another aspect, the invention provides an improvement to a processor of the type that provides functions within a system having a plurality of processor reset sources. The processor is made with an internal read register; that processor, and specifically, the read register, couples to the reset sources. One of the read register bits is set in response to a processor reset by a corresponding one of the reset sources. The processor then reads the set read register bit upon rebooting to determine which of the sources generated the processor reset.

In another aspect, the improvement further includes a first logic section with a plurality of latches. Each of the latches is uniquely coupled to one of the reset sources. Each of the reset sources sets a corresponding latch when generating a processor reset. The corresponding latch functions to set the read register bit to logic high.

In another aspect, the improvement further includes a second logic section with a write register to reset one of the latches set by the processor reset. A third logic section may also be included to write logic low to register bits of the write register, to clear enable the latches.

The invention is next described further in connection with preferred embodiments, and it will become apparent that various additions, subtractions, and modifications can be made by those skilled in the art without departing from the scope of the invention.

### BRIEF DESCRIPTION OF THE DRAWINGS

A more complete understanding of the invention may be obtained by reference to the drawings, in which:

FIG. 1 shows a system incorporating a processor reset register, in accord with the invention;

FIG. 2 illustrates a flow chart of a typical processor reset source detect operation for the system of FIG. 1; and

FIG. 3 shows a schematic diagram of processor reset detect apparatus constructed according to the invention.

### DETAILED DESCRIPTION OF THE EMBODIMENTS

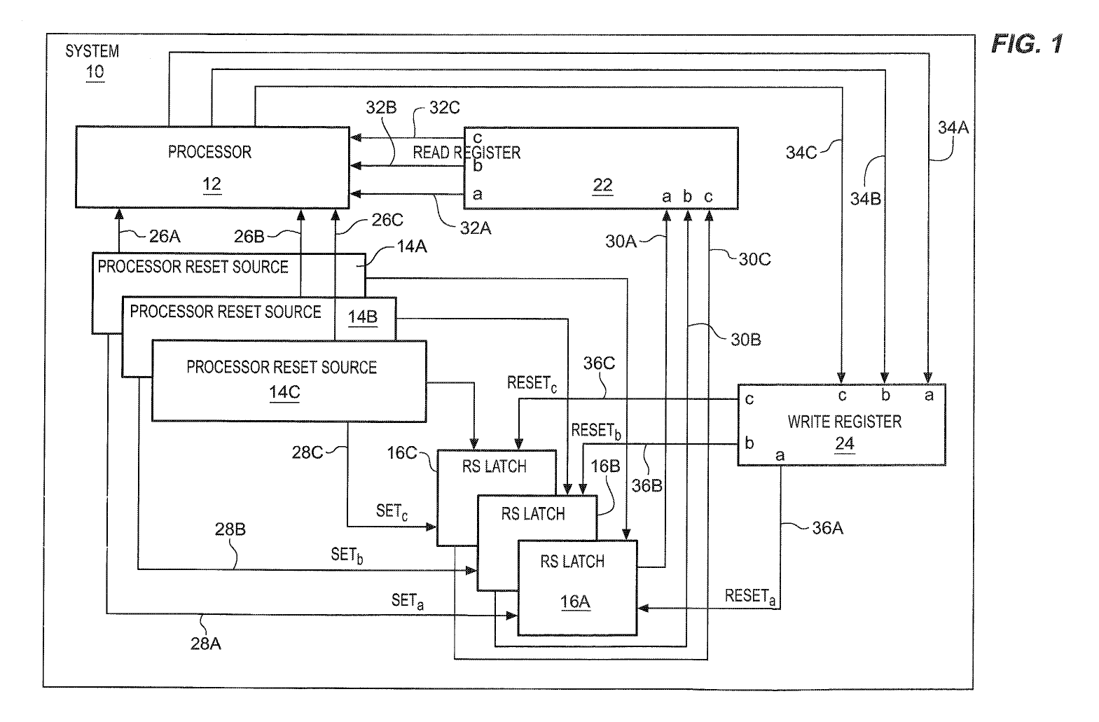

FIG. 1 shows a system 10 incorporating a processor 12, processor reset sources 14a-14c, RS latches 16a-16c, read register 22 and write register 24. System 10 illustratively shows signal lines 26a-26c coupling respective reset sources 14a-14c to processor 12; signal lines 28a-28c coupling respective reset sources 14a-14b to RS latches 16a-16c; signal lines 30a-30c coupling RS latches 16a-16c to respective register bits a-c of read register 22; signal lines 32a-32c coupling respective register bits a-c of read register 22 to processor 12; signal lines 34a-34c coupling processor 12 to respective register bits a-c of write register 24; and signal lines 36a-36c coupling register bits a-c of write register 24 to respective RS latches 16a-16c. Signal lines 28a-28c specifically couple processor reset sources 14a-14c to respective set pins of RS latches 16a-16c, as indicated by indicia Set_{a-c}; signal lines 36a-36c specifically couple register bits a-c of write register 24 to respective reset pins of RS latches 16a-16c, as indicated by indicia Reset_{a-c}.

System 10 is for example a processor-controlled product, and processor 12 is for example an embedded processor to control the product. Processor reset sources 14a, 14b, 14c represent devices that reset processor 12 via respective input signal lines 26a-26c. For purposes of illustration, source 14a may represent a push-button reset switch, source 14b may represent a watchdog reset timer, and source 14c may represent a power reset monitor. Read and write registers 22, 24 respectively have one bit a-c for each of sources 14a-14c. Those skilled in the art should appreciate that reset sources 14 can be combined, e.g., with a logical OR, to drive a single reset input to the processor as a matter of design choice.

In operation, the generation of a reset at processor 12 by a source 14 simultaneously feeds the set pin of corresponding RS latch 16. More particularly, each of reset sources 14a-14c generates a reset at processor 12 via a corresponding signal line 26a-26c; and the reset-generating reset source 14a-14c also drives a corresponding RS latch 16a-16b via corresponding signal line 28a-28c. For example, if processor reset source 14b generates a reset to processor 12 via input line 26b, source 14b also feeds the set pin of RS latch 16b via signal line 28b. When a RS latch 16 is set by a source 14, a logic high “1” is supplied to the corresponding input bit a-c of read register 22. Since register 22 has a bit for each of sources 14—illustratively shown as “a” for source 14a, “b” for source 14b, “c” for source 14c—that logic high specifies which reset source 14 generated a reset at processor 12. When processor 12 reboots, processor 12 reads bits a-c of register 22, through illustrative signal lines 32a-32c, to determine which source 14 generated the reset; that source 14 is identified by a logic high “1” set in the corresponding register bit a-c of read register 22.

In order to reset system 10 when system 10 reboots, and to continue tracking processor reset sources, the logic high bit a-c in register 22 is cleared. To clear the bit, processor 12 writes a logic high “1” to a bit position a-c of write register 24 corresponding to the last logic high bit position a-c of register 22. Processor 12 writes the “1” into the appropriate bit position a-c of write register 24 through one of illustrative signal lines 34a-34c. Write register 24 then feeds the reset input to corresponding RS latch 16 via corresponding signal line 36a-36c. Upon reset, a logic low “0” is supplied to read register 22, via corresponding signal line 30a-30c, and the register 22 set bit a-c is cleared. Processor 10 then writes a logic low “0” into every bit a-c of write register 24 to clear enable the resets of all latches 16 (failure to do so will freeze the latch at logic low).

A dedicated power-on reset may optionally be provided to reset the diagnosing circuitry of system 10, FIG. 1. By way of example, this reset may be made slightly longer than a power reset monitor source that feeds processor 12, FIG. 1. A dedicated power-on reset is especially useful if the diagnosing circuitry is on a different, and more persistently “on,” power rail than processor 12, e.g., such as on stand-by power or battery-backed power. When the circuitry powers up, it has its own reset to guarantee state. If processor 12 is powering at the same time, it is brought out of reset and may not see a reset state saved, assuming an initial power-on. However, if the rail to processor 12 dips and causes a reset to processor 12, the diagnosing circuitry is reset, on a different rail, and can latch the source. If the processor and diagnosing circuitry are on the same rail, a dedicated power reset may not be a useful input to a latch because the processor and diagnosing circuitry are reset in the case of a power dip.

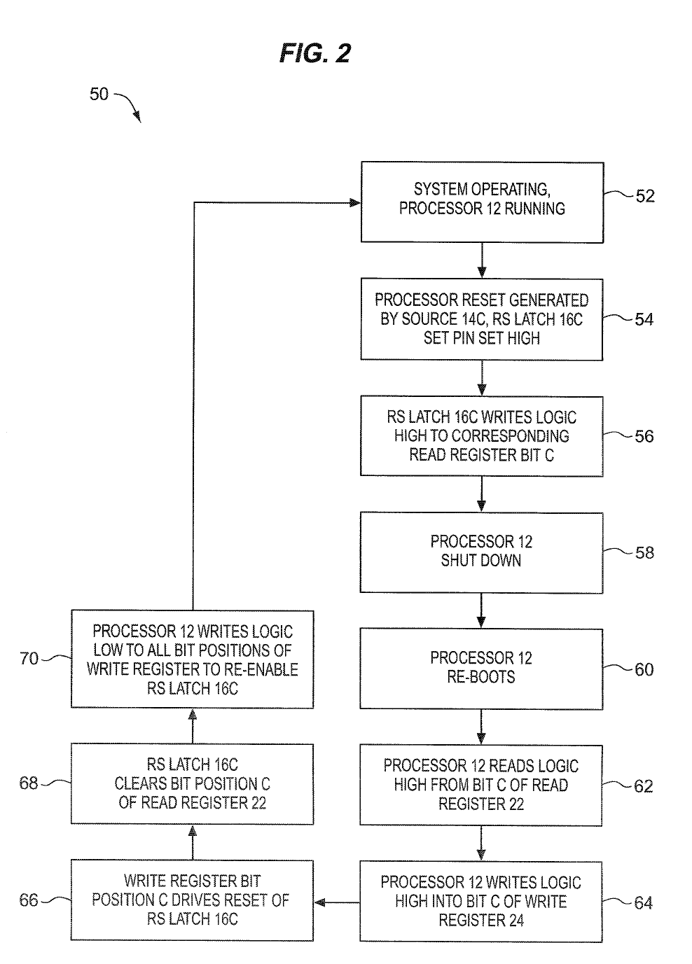

FIG. 2 is a flow chart 50 illustrating a typical processor reset, detection and recovery operation of system 10, FIG. 1. Initially, at step 52, system 10 is operational and processor 12 functions normally. A processor reset generated by reset source 14c, at step 54, resets processor 12 via signal line 26c; source 14c also feeds the set pin of RS latch 16c via signal line 28c. At step 56, RS latch 16c supplies a “1” to register bit c of read register 22, via signal line 30c. Processor 12 now shuts down due to the processor reset, at step 58. Processor 12 reboots at step 60. After rebooting, step 62, processor 12 reads bit c as a “1” from read register 22, through signal line 32c, to determine that processor reset source 14c generated the last processor reset. In step 64, processor 12 writes a “1” into bit position c of write register 24 via signal line 34c to initiate reset of bit position c of register 22. In step 66, bit position c of write register 24 feeds reset input of RS latch 16c across signal line 36c, resetting RS latch 16c. In step 68, RS latch 16c provides a “0” to read register 22, via signal line 30c, clearing bit position c of register 22; however the output of latch 16c remains non-enabled. At step 70, processor 12 writes a “0” into all bit locations a-c of write register 24 to re-enable latch 16c; system 10 is again ready to determine which source 16 generates a processor reset.

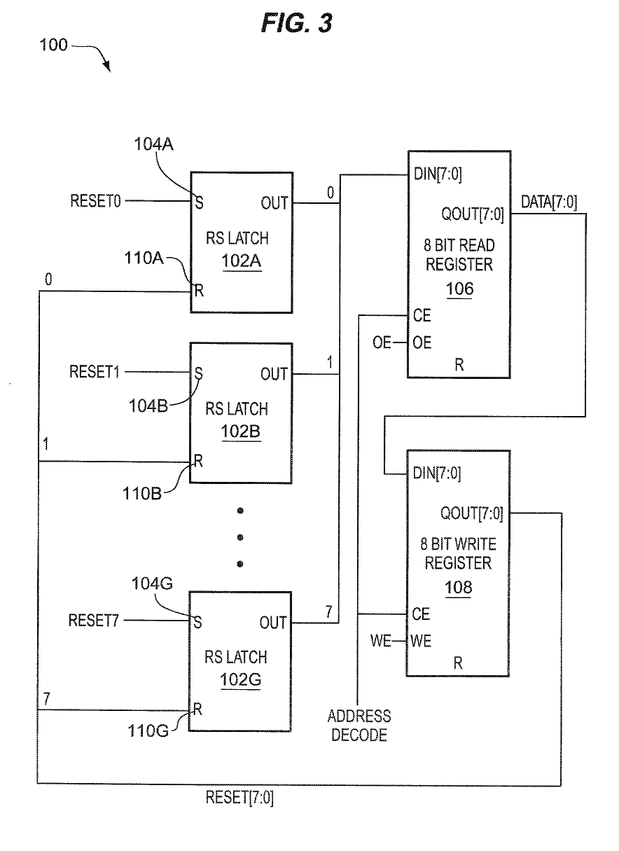

FIG. 3 shows a schematic 100 suitable for implementing certain logic within system 10, FIG. 1; schematic 100 may determine the source of a processor reset for up to eight such sources. As illustrated by Reset[7:0], a plurality of processor reset sources (e.g., sources 14) may connect to corresponding set pins 104a . . . 104g of an array of RS latches 102a . . . 102g. In response to generation of a processor reset by one of these reset sources, the corresponding one of RS latches 102a . . . 102g in turn drives logic high to the corresponding register bit DIN[7:0] of 8-bit read register 106. After rebooting, the processor may then read register bits DIN[7:0] of read register 106 to determine the source of the processor reset.

In resetting register bits of read register 106, the corresponding bit DOUT[7:0] of read register 106 drives logic high to the corresponding register bit DIN[7:0] of 8-bit write register 108, as shown. Register bits DOUT[7:0] then drive the corresponding reset pins 110a . . . 110g of RS latches 102a . . . 102g. Read register 106 is then cleared, and the processor writes logic low to reset latches 102, as described above.

The following Verilog source code provides a non-limiting simulation of processor reset detect circuitry constructed according to the invention. Those skilled in the art should appreciate that other simulations, source code, hardware design and/or electronic detail, as a matter of design choice, can similarly provide processor reset detect circuitry without departing from the scope of the invention. Those skilled in the art should thus appreciate that one or both of registers 22, 24, FIG. 1, may be implemented internally to processor 12 to perform the functions herein and without departing from the scope of the invention.

// --------------------------------------------------------------------------
// global FPGA reset and tristate control primitive
// --------------------------------------------------------------------------
//

| wire GSR_sig; | | | |
|---|---|---|---|
| assign GSR_sig = ˜GSR_sig_1; | | | |
| STARTUP startup( | .GSR | (GSR_sig), | //global reset input |

| | | |
|---|---|---|
| .GTS | (), | //global tristate input |

| | | |
|---|---|---|
| .CLK | (), | //synchronizes startup to user clock |

| | |
|---|---|
| .Q2 | (), |
| .Q3 | (), |

| | |
|---|---|
| .Q104 | (), |

| | |
|---|---|
| .DONEIN | ()); |

//bring in Xilinx global signals
glbl glbl();
// --------------------------------------------------------------------------
// Define resets
// --------------------------------------------------------------------------
wire wti_en;
wire bulkhead_reset;
wire reset_other_sp;
wire mem_flash_reset_out;
wire mem_flash_reset_in_1;

wire wd_reset;
wire [7:0] wd_multiple;
Reset Resets(

| | |
|---|---|
| .SP_CLK | (SP_CLK), |
| .CLK2HZ | (CLK2HZ), |
| .CLK1KHZ | (CLK1KHZ), |

| | |
|---|---|
| .CIO_CIO_SPARE_in | (CIO_CIO_SPARE_IN), |

| | |
|---|---|
| .CIO1_MATED_L | (CIO1_MATED_L), |

| .MEM_FLASH_RESET_IN_L(mem_flash_reset_in_l), | |
|---|---|
| .MEM_FLASH_RESET_OUT | (mem_flash_reset_out), |

| .CIO_CIO_SPARE_OUT (CIO_CIO_SPARE_OUT), | |
|---|---|
| .SP_ALIVE_L | (SP_ALIVE_L), |
| .BUFFER_EN | (BUFFER_ENABLE), |

| | |
|---|---|
| .RESET_SP_ALL_L | (RESET_SP_ALL_L), |

| | |
|---|---|
| .RESET_SP_L | (RESET_SP_L), |

| | |
|---|---|
| .WTI_EN | (wti_en), |
| .SP_WTI | (SP_WTI), |

| | |
|---|---|
| .SP_FPGA_WTI | (SP_FPGA_WTI), |
| .RESET_OTHER_SP | (reset_other_sp), |
| .BULKHEAD_RESET | (bulkhead_reset), |

| | |
|---|---|
| .GSR | (GSR_SIG), |

| | |
|---|---|
| .wd_reset | (wd_reset),//010502 |
| .WD_MULTIPLE | (wd_multiple));//010504 |

assign MEM_FLASH_RESET_L = mem_flash_reset_out ? 1′b0 : 1′bz;
assign mem_flash_reset_in_l = MEM_FLASH_RESET_L;
// --------------------------------------------------------------------------
// Implement Memory Mapped Registers and interrupt routing
// --------------------------------------------------------------------------
wire SP_INT;
wire [21:0] regs_addr_min, reg_addr_max;
wire regs_cs;
//regs #(fpga_rev,regs_base_addr) regs(

regs #(fpga_rev,regs_base_addr,box_id) regs(

| .CLK2HZ | (CLK2HZ), |
|---|---|
| .ADDR (ADDRESS), | |
| .DATAIN (DATA_IN[7:0]), | |
| .DATAOUT (INT_DATA[7:0]), | |
| .CS | (˜SRAM_CS_L[3]), |
| .RD | (˜OE_L), |
| .WR | (˜WE_L), |

.BRD_REV({

4′b0000,
˜ASSY_REV_ID}),//default is pulled up

| | | |
|---|---|---|
| .INT_SRC({ | ˜BATTWARN_L, | // bit 7: Battery warning added 000927 |

| ˜PCI_PME_SP_L, | // bit 6: SP_PME |
|---|---|
| ˜PCI_PME_L, | // bits 5-4: PCI_PMEs |
| ˜GPM_IRQ_L, | // bit 3: GPM interrupt, |
| UART_SPLINK_INT,// bit 2: DUART int (active high), | |
| UART_ICMB_INT, | // bit 1: DUART int (active high), |

˜WD_INT_L}), // bit 0: Watchdog int

| | |
|---|---|
| .INT | (SP_INT), |

| .SLOT_STATUS({5′b00000, | | |
|---|---|---|
| | ˜CIO2_PRSNT_L, | |
| | ˜CIO1_MATED_L, | |
| | SLOT_ID}), | |
| .WTI_EN | (wti_en), | //fw controlled wti enable |

.RST_OTHER_SP(reset_other_sp), //resets 2nd SP asynchronously

//comes in to FPGA from other SP as RST_BYOTHER_SP_L

| .BULKHEAD_RESET (bulkhead_reset), | |
|---|---|
| .RESET | (!MEM_FLASH_RESET_L \| GSR_sig),//clear when SP is reset |

| | | |
|---|---|---|
| .GSR | (GSR_sig), | //only reset at powerup |

| | |
|---|---|
| .RESET_SRC | ({3′h0,˜CIO_CIO_SPARE_IN,//010502 |

CIO1_MATED_L,//010502
˜MEM_FLASH_RESET_L,//010502
mem_flash_reset_out,//010502
wd_reset}),//010502

.WD_MULTIPLE(wd_multiple));

assign SP_INT_L = ˜SP_INT;
// Finally, the magic that will make this work
// Define the memory range for the FPGA regs
assign regs_addr_min = regs_base_addr;
assign regs_addr_max = regs_base_addr + 22′d256;
//Define the chip select for the FPGA regs
wire regs_cs1;
wire regs_cs2;
wire regs_cs3;
assign regs_cs1 = (ADDRESS >= regs_addr_min);
assign regs_cs2 = (ADDRESS < regs_addr_max);
assign regs_cs3 = (˜SRAM_CS_L[3]);
assign regs_cs = (regs_cs1 & regs_cs2 & regs_cs3);
//Drive data bus during read from FPGA regs
assign DATA[7:0] = (˜OE_L & regs_cs) ? INT_DATA: 8′bZ;

| | |
|---|---|
| // | |
| // FileName | : CIO.v |

| | |
|---|---|
| // | : |

| | |
|---|---|
| //Purpose | : Provide memory mapped registers and hit routing |

| | |
|---|---|
| // | : |

| | |
|---|---|
| // IncludeFiles | : none |

| | |
|---|---|
| // | : |

| | |
|---|---|
| // Conventions | : Active low signals are identified with‘_l’ or ‘_L’ |

| | |
|---|---|
| // | : |

// INT_DATA is the bus driven out of the FPGA
// DATA_IN is the bus driven into the FPGA
module regs(

CLK2HZ,
ADDR,

DATAIN,
DATAOUT,

CS,
RD,
WR,
BRD_REV,
INT_SRC,
RESET,
GSR,
INT,
SLOT_STATUS,
WTI_EN,
RST_OTHER_SP,
BULKHEAD_RESET,
RESET_SRC,//010502
WD_MULTIPLE
);

parameter fpga_rev = 8′h00;
//parameter base_addr = 30′h3C20000;
parameter base_addr = 22′h020000;
parameter box_id = 8′h00;
parameter width = 8;
parameter fpga_rev_reg_addr = base_addr + 22′h0; //FPGA revision, RO

| | |
|---|---|
| parameter brd_rev_reg_addr = base_addr + 2; | //Board rev resistors, RO |
| parameter int_src_reg_addr = base_addr + 4; | //Interrupt source reg, RO |
| parameter int_mask_reg_addr = base_addr + 6; | //Interrupt masks, RW |
| parameter scratch_reg_addr = base_addr + 8; | //Scratch, only reset at powerup, RW |

| | |
|---|---|
| parameter slot_status_reg_addr = base_addr + 4′ha; | //Slot info, RO |

| | |
|---|---|
| parameter wd_en_reg_addr = base_addr + 4′hc; | //Watchdog enable, RW |

| | |
|---|---|
| parameter sp_restore_reg_addr = base_addr + 4′he; | //Restore defaults flag |

| | |
|---|---|
| parameter sp_rst_reg_addr = base_addr + 8′h10; | //Reset control, clear restore flag |

| | |
|---|---|
| parameter box_id_reg_addr = base_addr + 8′h12; | //Box ID |

parameter sp_rstsrc_reg_addr = base_addr + 8′h14;//010502
parameter wd_mult_reg_addr = base_addr + 8′h16;//WD timeout multiplier

| | |
|---|---|
| input | CLK2HZ; |

| | | |
|---|---|---|
| input [21:0] | ADDR; | //processor address bus |

| | |
|---|---|
| input [width-1:0] DATAIN; | //processor data bus in |
| output [width-1:0] DATAOUT; | //processor data bus out |

| | |
|---|---|
| input CS; | //FPGA regs chip select |
| input RD; | //memory read |
| input WR; | //memory write |

| | |
|---|---|
| input [width-1:0] BRD_REV; | //assembly rev |
| input [width-1:0] INT_SRC; | //interrupt source |

| | |
|---|---|
| input RESET; | //general processor reset |

| | |
|---|---|
| input GSR; | //FPGA global Power up reset |
| output INT; | //interrupt to processor |

| | |
|---|---|
| output WTI_EN; | //watchdog timer enable |

input [width-1:0] SLOT_STATUS;//board slot info
output RST_OTHER_SP;
input BULKHEAD_RESET;
input [width-1:0] RESET_SRC;
output [width-1:0] WD_MULTIPLE;
// ----------------------------------------------------------------------
// -------------------------------------------------------------------------
// Implement Watchdog enable register
// --------------------------------------------------------------------------
//

wire [6:0] wti_en_stub;
RWasyncReg8 wd_en_reg (

| .RESET (RESET), // in, powerup reset | |
|---|---|
| .CE | (CS && ADDR == wd_en_reg_addr), // in, Address Decode |
| .OE | (RD), // in, Read Control |
| .WE | (WR), // in, Write control |
| .DIN | (DATAIN), |
| .TOUT | (DATAOUT), |
| .QOUT | ({wti_en_stub[6:0], |

// --------------------------------------------------------------------------
// Detect reset source 010502
// --------------------------------------------------------------------------
wire [4:0] clear_rstsrc_flag;
wire [4:0] rst_src;
//Latch source
RS_latch RS0(

| | |
|---|---|
| .SET | (RESET SRC[0]), |
| .RESET | (clear_rstsrc_flag[0] \| GSR), |
| .QOUT | (rst_src[0])); |

RS_latch RS1(

| | |
|---|---|
| .SET | (RESET SRC[1]), |
| .RESET | (clear_rstsrc_flag[1] \| GSR), |
| .QOUT | (rst_src[1])); |

RS_latch RS2(

| | |
|---|---|
| .SET | (RESET_SRC[2]), |
| .RESET | (clear_rstsrc_flag[2] \| GSR), |
| .QOUT | (rst_src[2])); |

RS_latch RS3(

| | |
|---|---|
| .SET | (RESET SRC[3]), |
| .RESET | (clear_rstsrc_flag[3] \| GSR), |
| .QOUT | (rst_src[3])); |

RS_latch RS4(

| | |
|---|---|
| .SET | (RESET_SRC[4]), |
| .RESET | (clear_rstsrc_flag[4] \| GSR), |
| .QOUT | (rst_src[4])); |

// -------------------------------------------------------------------------
// Implement RESET SOURCE REG
// The flag is cleared by writing 0 to bit 0 at this address
// --------------------------------------------------------------------------
//

RReg8 sp_rstsrc_reg(

| .CE | (CS && ADDR == sp_rstsrc_reg_addr), // in, Address Decode | |
|---|---|---|
| .OE | (RD), | // in, Read Control |
| .DIN | ({3′h0, | |

rst_src[4:0]}),

| | |
|---|---|
| .TOUT | (DATAOUT)); |

// Clear RESET SOURCE REG when 1 is written to bit 0 at this address
// Firmware should then write 0 to allow normal operation
wire [2:0] clear_src_stub;
WasyncReg8 sp_rstsrc_wr_reg (

| | |
|---|---|
| .RESET | (GSR), |

| | |
|---|---|
| .CE | (CS && ADDR == sp_rstsrc_reg_addr), // in, Address Decode |
| .WE | (WR), // in, Read Control |
| .DIN | (DATAIN), |
| .QOUT | ({clear_src_stub[2:0], |

clear_rstsrc_flag}));

endmodule

The invention thus attains the objects set forth above, among those apparent from the preceding description. Since certain changes may be made in the above methods and systems without departing from the scope of the invention, it is intended that all matter contained in the above description or shown in the accompanying drawing be interpreted as illustrative and not in a limiting sense. It is also to be understood that the following claims are to cover all generic and specific features of the invention described herein, and all statements of the scope of the invention which, as a matter of language, might be said to fall there between.

What is claimed is:

1. A method of determining the source of a processor reset in a system having a processor and a plurality of processor reset sources, comprising the steps of:
coupling the plurality of processor reset sources to a corresponding plurality of latches;
setting one of the latches in response to a processor reset generated by a corresponding one of the processor resets;
writing logic high to a first register bit of a read register and designated by the one latch;
rebooting the processor; and
reading the first register bit from the read register to determine which of the reset sources generated the processor reset.

2. A method of claim 1, further comprising the step of resetting the read register to determine a subsequent processor reset source.

3. A method of claim 2, wherein the step of resetting the read register comprises resetting the first register bit.

4. A method of claim 2, wherein the step of resetting the read register comprises the step of writing logic high to a second register bit of a write register and corresponding to the first register bit.

5. A method of claim 4, wherein the step of resetting the read register comprises the step of resetting the one latch through the logic high register bit of the write register.

6. A method of claim 5, further comprising the step of writing logic low to the first register bit and through the one latch.

7. A method of claim 6, further comprising the step of clear enabling the latches.

8. A method of claim 7, wherein the step of clear enabling the latches comprises the step of writing logic low to register bits of the write register.

9. A method of claim 1, wherein the step of coupling the plurality of processor reset sources to a corresponding plurality of latches comprises coupling the plurality of processor reset sources to a corresponding plurality of RS latches.

10. Logic apparatus for coupling with a processor and a plurality of processor reset sources to determine which of the sources generated a processor reset, comprising:
a plurality of latches, each of the latches being uniquely coupled to one of the reset sources, each of the reset sources setting a corresponding latch when generating a processor reset; and
a read register coupled to the latches, each of the latches setting logic high in a corresponding read register bit of the read register in response being set by a processor reset, the processor reading the register bit after rebooting to determine which of the sources generated the reset.

11. Apparatus of claim 10, further comprising a write register, the read register and processor cooperating to set logic high in a write register bit of the write register that corresponds to the read register bit, the write register being coupled with the latches to reset one of the latches set by the processor reset.

12. Apparatus of claim 11, the one latch resetting logic low to the read register bit in response to being reset by the write register.

13. Apparatus of claim 11, the processor writing logic low to each write register bit of the write register to clear enable the latches.

14. Apparatus of claim 11, wherein at least one of the write and read registers comprises an 8-bit register.

15. Apparatus of claim 10, wherein at least one of the latches comprises a RS latch.

16. In a processor providing functions to a system having a plurality of processor reset sources, the improvement comprising a read register, coupled to the reset sources, for setting one of its read register bits in response to a processor reset by one of the reset sources, the processor reading the one read register bit upon rebooting to determine which of the sources generated the processor reset.

17. In a processor of claim 16, the further improvement comprising a first logic section having a plurality of latches, each of the latches being uniquely coupled to one of the reset sources, each of the reset sources setting a corresponding latch when generating a processor reset, the corresponding latch setting the one read register bit to logic high.

18. In a processor of claim 17, the further improvement comprising a second logic section having a write register for resetting one of the latches set by the processor reset.

19. In a processor of claim 18, the further improvement comprising a third logic section for writing logic low to register bits of the write register to clear enable the latches.

20. In a processor of claim 18, the further improvement wherein the one latch clears the one read register bit in response to being reset by the write register.
